(19) United States
(12) Patent Application Publication
(10) Pub. No.: US 2010/0147468 A1
(43) Pub. Date: Jun. 17, 2010

(54) ROMAN SHADE ASSEMBLY

(76) Inventors: Wen Ying Liang, Fuxing Shiang (TW); Sheng Ying Hsu, Fuxing Shiang (TW); Wu Chung Nien, Fuxing Shiang (TW); Chien Chin Huang, Fuxing Shiang (TW)

Correspondence Address: PHILLIP LIU, 6980, WHITEOAK DRIVE, RICHMOND, V7E 4Z9, CA

(21) Appl. No.: 12/333,163

(22) Filed: Dec. 11, 2008

(51) Int. Cl. E06B 9/24; A44B 18/00

(52) U.S. Cl. 160/84.04; 24/442

(57) ABSTRACT

A Roman shade assembly includes a frame and a shade which is removably connected to the frame. The shard is composed of an inner portion and an outer portion. The inner portion has one end connected to the frame and a first connection member is connected to an outside of the end of the inner portion. Multiple first male members are connected to the inner portion. The outer portion has a second connection member connected to an inside of an end thereof and the second connection member is connected to the first connection member of the inner portion. Multiple first female members are connected the inside of the outer portion and connected to the first male member. The inner and outer portions can be easily separated from each other by disengaging the first male and female members.

### FIELD OF THE INVENTION

The present invention relates to a Roman shade assembly, and more particularly, to a connection device to connect the inner portion and the outer portion conveniently.

### BACKGROUND OF THE INVENTION

One of the conventional Roman shades generally includes a frame and an inner portion is connected with the frame, and an outer portion is fixed to the inner portion so as to form specific profile of the shade. The inner and outer portions are both made by soft and flexible material such as fabric so that the shade can be extended to a desired height to keep the light from the interior of the rooms.

However, the conventional Roman shades is difficult to clean because the inner and outer portions are fixed as one piece which is bulky and heavy, so that it is difficult for the users to remove the combination of the inner and outer portions from the frame and clean it. Besides, because the inner and outer portions are fixed as one piece so that the users cannot change the color of the outer portion while the inner portion is remained the same one.

The present invention intends to provide a Roman shade assembly which includes a frame and a shade, the shade is composed of an inner portion and an outer portion which is connected to the inner portion by using hook and loop connection members, and by using male and female members.

### SUMMARY OF THE INVENTION

The present invention relates to a Roman shade assembly which comprises a frame and an inner portion has one end connected to the frame. A first connection member is connected to an outside of the end of the inner portion. Multiple passages are defined transversely through the inner portion and each passage has a positioning rod received therein. Multiple first male members are connected to the inner portion and located above the passages. An outer portion has a second connection member which is connected to the first connection member of the inner portion. Multiple first female members are connected the inside of the outer portion and connected to the first male member.

The primary object of the present invention is to provide a Roman shade assembly wherein the inner portion and the outer portion of the shade can be easily separated or assembled.

Another object of the present invention is to provide a Roman shade assembly wherein the inner portion and the outer portion are connected to each other male and female members.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the Roman shade assembly of the present invention;

FIG. 2 is an exploded view to show the first embodiment of the Roman shade assembly of the present invention;

FIG. 3 is a cross sectional view to show the connection of the first male member and the first female members of the first embodiment of the Roman shade assembly of the present invention;

FIG. 4 shows the Roman shade assembly of the present invention, wherein the outer portion is removed from the inner portion;

FIG. 5 is an exploded view to show the second embodiment of the Roman shade assembly of the present invention, and

FIG. 6 is a cross sectional view to show the connection of the second male member and the second female members of the second embodiment of the Roman shade assembly of the present invention.

### DETAILED DESCRIPTION OF THE PREFERRED EMBODIMENT

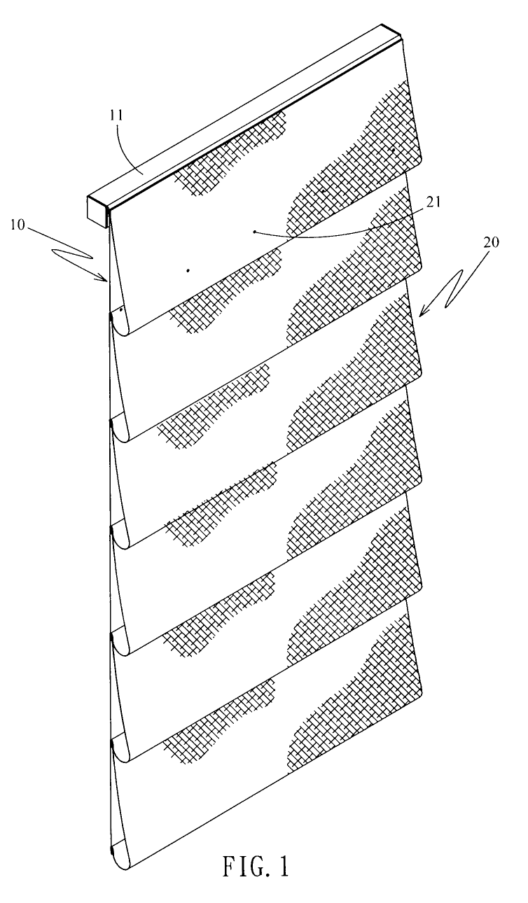

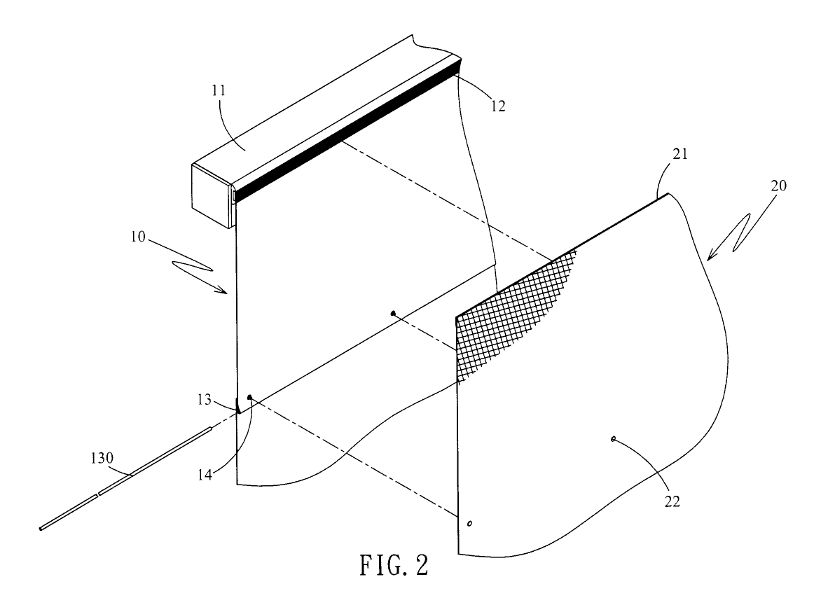

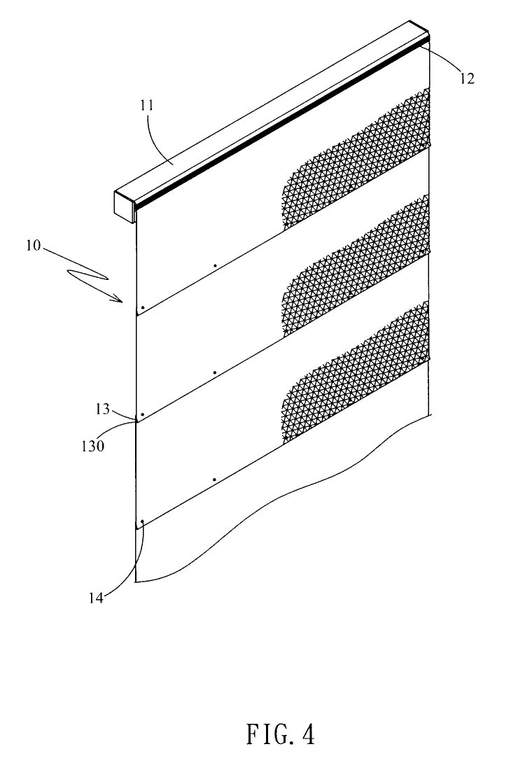

Referring to FIGS. 1 to 4, the Roman shade assembly of the present invention comprises a frame 11 and a shade which is composed of an inner portion 10 and an outer portion 30. The frame 11 is fixed to the wall or a window frame (not shown) and the inner portion 10 has one end connected to the frame 11. A first connection member 12 such as a hook-loop member is connected to an outside of the end of the inner portion 10. Multiple passages 13 are defined transversely through the inner portion 10 and each passage 13 has a positioning rod 130 received therein. Multiple first male members 14 are connected to the inner portion 10 and located above the passages 13.

The outer portion 20 has a second connection member 21 which is a hook-loop member connected to an inside of an end thereof, so that the second connection member 21 is connected to the first connection member 12 of the inner portion 10 to connect two respective ends of the inner and outer portions 10, 20. Multiple first female members 22 are connected the inside of the outer portion 20 and can be connected to the first male member 14 to let the outer portion 20 have a wave-shaped profile as shown in FIG. 1.

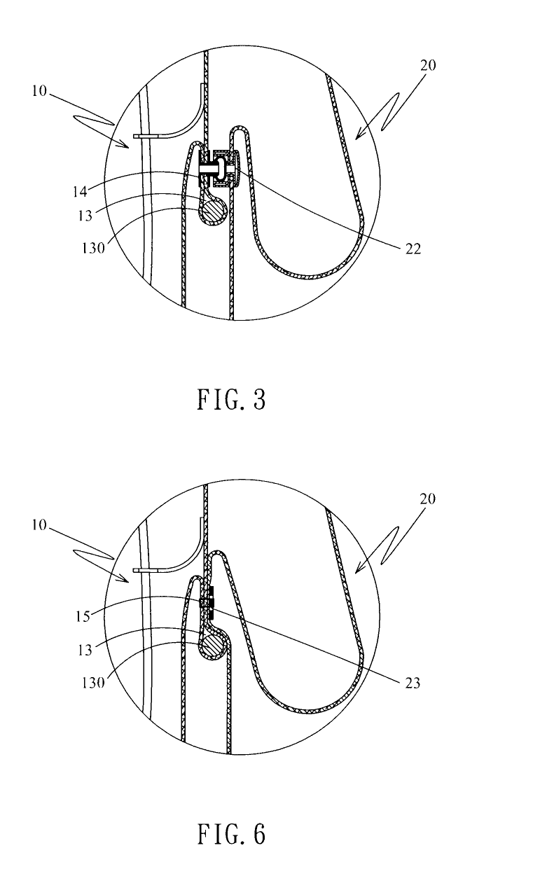

As shown in FIG. 3, the first male members 14 include a protrusion which is removably engaged with a recess defined in the first female member 22. By this way, the users can easily assemble the outer portion 20 to the inner portion 10, and the outer portion 20 can also be easily replaced with different style and color as needed without extra skill or tools required.

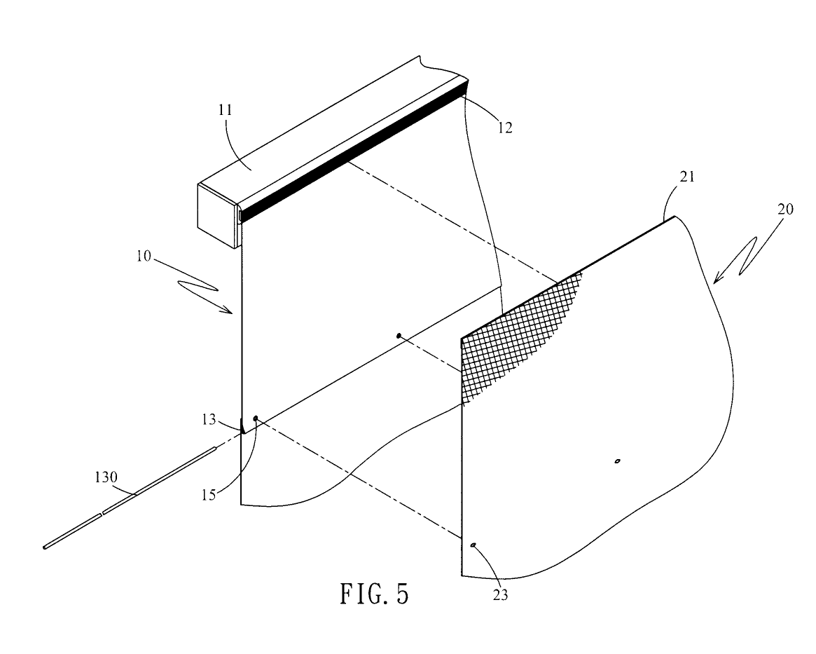

FIGS. 5 and 6 show a second embodiment of the Roman shade assembly which is similar to the first embodiment and comprises a frame 11, an inner portion 10 having one end connected to the frame 10, and an outer portion 20 having a second connection member 21 connected to an inside of an end thereof. The second connection member 21 is connected to the first connection member 12 of the inner portion 10.

Multiple passages 13 are defined transversely through the inner portion 10 and each passage 13 has a positioning rod 130 received therein. Multiple second male members 15 are connected to the inner portion 10 and located above the passages 13. The outer portion 20 has multiple second female members 23 connected to the inside of the outer portion 20 and can be connected to the second male member 15.

The difference from the first embodiment is that the second male members 15 are made as buttons and the second female members 23 are made as buttonholes through which the second male members 15 are secured.

While we have shown and described the embodiment in accordance with the present invention, it should be clear to those skilled in the art that further embodiments may be made without departing from the scope of the present invention.

What is claimed is:

1. A Roman shade assembly comprising:
a frame and an inner portion having one end connected to the frame, a first connection member connected to an outside of the end of the inner portion, multiple passages defined transversely through the inner portion and each passage having a positioning rod received therein, multiple first male members connected to the inner portion and located above the passages, and
an outer portion having a second connection member connected to an inside of an end thereof, the second connection member connected to the first connection member of the inner portion, multiple first female members connected the inside of the outer portion and connected to the first male member.

2. The assembly as claimed in claim 1, wherein the first connection member and the second connection member are hook-loop members.

3. A Roman shade assembly comprising:
a frame and an inner portion having one end connected to the frame, a first connection member connected to an outside of the end of the inner portion, multiple passages defined transversely through the inner portion and each passage having a positioning rod received therein, multiple second male members connected to the inner portion and located above the passages, and
an outer portion having a second connection member connected to an inside of an end thereof, the second connection member connected to the first connection member of the inner portion, multiple second female members connected the inside of the outer portion and connected to the second male member.

4. The assembly as claimed in claim 3, wherein the first connection member and the second connection member are hook-loop members.
